(19) United States
(12) Patent Application Publication
(10) Pub. No.: US 2025/0059313 A1
(43) Pub. Date: Feb. 20, 2025

(54) POLYMER COMPOSITION FOR PIPES HAVING VERY GOOD IMPACT PROPERTIES AND SLOW CRACK GROWTH RESISTANCE

(71) Applicant: BOREALIS AG, Vienna (AT)

(72) Inventors: Andrey BURYAK, Linz (AT); Victor SUMERIN, Kulloo (FI)

(73) Assignee: BOREALIS AG, Vienna (AT)

(21) Appl. No.: 18/722,851

(22) PCT Filed: Dec. 12, 2022
(86) PCT No.: PCT/EP2022/085465

§ 371 Date: Jun. 21, 2024

(30) Foreign Application Priority Data
Dec. 23, 2021 (EP) 21217316.5

(51) Int. Cl. C08F 297/08; C08K 3/04

(52) U.S. Cl. CPC C08F 297/083; C08K 3/04

(57) ABSTRACT

A polymer composition comprising a base resin, the base resin comprising (A) a first ethylene homo- or copolymer fraction, and (B) a second ethylene-hexene-1 copolymer fraction, wherein fraction (A) has a lower molecular weight than fraction (B), wherein the polymer composition has a content of 1-hexene of more than 1.5 wt % with respect to the total weight of the polymer composition; wherein the weight ratio of the fraction (A) to the fraction (B) is from 44:56 to 35:65; wherein the base resin has a density of equal to or higher than 945 kg/m³, and wherein the polymer composition has a MFR₅ (190° C., 5 kg) of equal to or higher than 0.5 g/10 min and equal to or lower than 0.7 g/10 min.

### FIELD OF THE INVENTION

The present invention relates to a polymer composition having very good impact properties and slow crack growth resistance, a multistage process for producing said polymer composition, an article comprising said polymer composition, a pipe and use of said polymer composition for producing an article.

### BACKGROUND

Polyolefin pipes and especially polyethylene pipes are conventionally used for transport of water, gas as well as industrial liquids and slurries. Due to their versatility, ease of production and installation as well as non-corrosivity, their use is constantly increasing.

The transported fluids may have varying temperatures, usually within the temperature range from about 0° C. to about 50° C. According to ISO 9080 polyethylene pipes are classified by their minimum required strength, i.e. their capability to withstand different hoop stresses during 50 years at 20° C. without fracturing. Thereby, pipes withstanding a hoop stress of 8.0 MPa (MRS8.0) are classified as PE80 pipes, and pipes withstanding a hoop stress of 10.0 MPa (MRS10.0) are classified as PE100 pipes. The service temperature for PE100 is usually within the temperature range from about 0° C. to about 50° C.

To meet the PE80 requirements with multimodal resins manufactured by conventional Ziegler-Natta catalysts, the density needs to be at least 940 kg/m³ and to meet PE100 requirements the density needs to be above 945 kg/m³. However, the density of a polyethylene resin is directly connected with its crystallinity. The higher the crystallinity of a polyethylene resin the lower its slow crack growth resistance. In other words, all polyethylene materials for pressure resistance of a pipe suffer from the dependency of crystallinity and insofar density and the slow crack growth. When the density is increased, the resistance to slow crack growth (SCG) decreases.

The manufacture of polyethylene materials to be used in pressure pipes is discussed for example in an article by Scheirs et al. (Scheirs, Bohm, Boot and Leevers: PE100 Resins for Pipe Applications, TRIP Vol. 4, No 12 (1996) pp. 408-415).

Targets for pipes for the transport of pressurized fluids (so called pressure pipes) to withstand higher and higher (internal) design stresses involve both a higher creep resistance and a higher stiffness. On the other hand, pressure pipes must also fulfil demanding requirements as to their rapid as well as slow crack propagation resistance, must have low brittleness and high impact strength. However, these properties are contrary to each other so that it is difficult to provide a composition for pipes which excels in all of these properties simultaneously. Furthermore, as polymer pipes generally are manufactured by extrusion, or, to a smaller extent, by injection moulding, the polymer composition also must have good processability.

It is known that in order to comply with the contrary requirements for a pipe material bimodal polymer compositions may be used. Such compositions are described e.g. in EP 0 739 937 and WO 02/102891. The bimodal polymer compositions described in these documents usually comprise a low molecular weight polyethylene fraction and a high molecular weight fraction of an ethylene copolymer comprising one or more alpha-olefin comonomers.

EP 1 985 660 A1 discloses a pipe or a supplementary pipe article with improved slow crack growth resistance comprising a polymer composition comprising a base resin, which comprises a first ethylene homo- or copolymer fraction (A), and a second ethylene homo-or copolymer fraction (B), wherein fraction (A) has a lower average molecular weight than fraction (B), and wherein the base resin has a density in the range of 945 to 949 kg/m³, an MFR₅ in the range of 0.2 to 0.4 g/10 min, a comonomer content of higher than 2.0 wt % and a SHI_{(2.7/210)} in the range of 55 to 100. The examples of EP 1 985 660 A1 show a carbon black content of not more than 2.3 wt %. Still, the impact properties of the material can be improved.

New installation techniques demand PE resins with higher and higher resistance to slow crack growth. The requirements for slow crack growth become more and more stringent and many of the existing products fail to consistently meet those requirements. At the same time, there is the need to improve the impact resistance of the HDPE pipe resins in order to avoid pipelines' failure by rapid crack propagation.

To connect polyethylene pipe, fittings made from polyethylene are commonly used. For the connection of pipes produced from a PE100 polymer composition, the material of the fittings also needs to be PE100-certified. Generally, fittings are—due to their complex shape—produced by injection moulding. Injection moulding requires that processability of the moulded polymer composition is high, i.e. that the melt flow rate of the polymer composition is high. Such high melt flow rate guarantees acceptable flowability. For example, polyethylene polymer known from the prior art intended for the production of fitting by injection moulding typically have a MFR₅ of 0.40 to 0.60 g/10 min—double that of a conventional PE100 resin with the typical MFR₅ of 0.20 to 0.30 g/10 min. However, increasing the MFR₅ of the base resin has a negative effect on the slow crack growth resistance and pressure resistance of the polymer, which are equally important properties needed for PE100 certification. It is further known that the slow crack growth resistance and the short term pressure resistance are also antagonistic properties. Hence, there is a general interest to optimize balance of the antagonistic properties of processability, resistance to slow crack growth and pressure resistance.

Moreover, in the recent years resistance to crack (RC) PE100 resins are gaining popularity thanks to their tolerance to harsh installation conditions. It can be expected that the fittings made from a PE100-RC materials will be demanded for connection of such pipes. PE100-RC resins need to have even higher resistance to slow crack growth than the conventional PE100, making the achievement of the balance between acceptable flowability and superior slow crack growth resistance even more difficult.

WO 2005/121238 A1 is concerned with base resins for fittings of pipes and discloses a polyethylene resin having an MFR₅ of from 0.40 to 0.70 g/10 min, and comprising from 47 to 52 wt % of a low molecular weight polyethylene fraction, and from 48 to 53 wt % of a high molecular weight polyethylene fraction, wherein the high molecular weight polyethylene fraction comprises a copolymer of ethylene and either 1-hexene or 1-octene. However, the slow crack growth resistance of the disclosed base resin still can be improved.

### OBJECT OF THE INVENTION

It is an object of the present invention to provide a polyethylene pipe material which has an improved balance of slow crack growth resistance, short term pressure resistance and processability without sacrificing other pipe-application related properties such as impact properties.

The present invention is based on the surprising finding that such a pipe material can be provided by selecting a specific combination of the properties of a multimodal polyethylene composition in terms of a specific range for the MFR₅ implementing a certain split of the low molecular weight fraction and the high molecular weight fraction, and a minimum 1-hexene content in the high molecular weight fraction.

### SUMMARY OF THE INVENTION

The present invention therefore provides a polymer composition comprising a base resin, the base resin comprising:
(A) a first ethylene homo-or copolymer fraction, and
(B) a second ethylene-hexene-1 copolymer fraction,
wherein fraction (A) has a lower molecular weight than fraction (B),
wherein the composition has a content of units derived from 1-hexene of more than 1.5 wt % with respect to the total weight of the composition;
wherein the weight ratio of the fraction (A) to the fraction (B) is from 44:56 to 35:65;
wherein the base resin has a density of equal to or higher than 945 kg/m³, and
wherein the composition has a MFR₅ (190° C., 5 kg, ISO 1133) of equal to or higher than 0.5 g/10 min and equal to or lower than 0.7 g/10 min.

Furthermore, the present invention provides a process for producing said polymer composition. Additionally, the present invention provides an article comprising said polymer composition. Finally, the present invention provides the use of said polymer composition for producing an article.

### DETAILED DESCRIPTION OF THE INVENTION

### Composition of the present invention

The present invention provides a polymer composition comprising a base resin, the base resin comprising:
(A) a first ethylene homo-or copolymer fraction, and
(B) a second ethylene-hexene-1 copolymer fraction,
wherein fraction (A) has a lower molecular weight than fraction (B),
wherein the composition has a content of units derived from 1-hexene of more than 1.5 wt % with respect to the total weight of the composition;
wherein the weight ratio of the fraction (A) to the fraction (B) is from 44:56 to 35:65;
wherein the base resin has a density of equal to or higher than 945 kg/m³, and
wherein the composition has a MFR₅ (190° C., 5 kg, ISO 1133) of equal to or higher than 0.5 g/10 min and equal to or lower than 0.7 g/10 min.

The polymer composition of the invention due to its combination of design parameters allows to achieve excellent resistance to slow crack growth combined with very good processability, while still meeting all other requirements of a PE100 resin.

The expression ‘ethylene homopolymer’ according to the present invention relates to an ethylene polymer that consists substantially, i.e. to at least 99% by weight, more preferably at least 99.5% by weight, still more preferably at least 99.8% by weight of ethylene and most preferably is an ethylene polymer which only includes ethylene monomer units.

The term ‘base resin’ means the entirety of polymeric components in the polymer composition according to the invention, i.e. it denotes the polymeric part of the composition without fillers such as carbon black. The base resin usually is making up at least 90 wt % of the total composition. Preferably, the base resin is consisting of polymer fractions (A) and (B), optionally further comprising a pre-polymer fraction in an amount of up to 10 wt %, more preferably up to 7 wt %, and most preferably up to 5 wt % of the total base resin. A person skilled in the art will understand that measurements as to properties of the base resin require the presence of stabilizers. In this invention, the indication of the weight amount of fraction (A) includes the weight amount of the prepolymer fraction, if not indicated as an individual fraction. This also applies to the indications of the weight ratios between fractions (A) and (B). The slow crack growth resistance of a pipe material is imparted to the material by the base resin, and can, for example, be tested by the notched pipe test and the strain hardening behaviour of the resin.

Hence, preferably, the polymer composition of the present invention has a strain hardening modulus of 50 MPa or higher, more preferably of 55 MPa or higher, still more preferably has of 60 MPa or higher, and most preferably of 65 MPa or higher. Typically, the strain hardening modulus is not higher than 90 MPa.

Furthermore, the polymer composition of the present invention preferably has a slow crack growth value in a notched pipe test (NPT, 80° C., 4.6 MPa) of at least 3500 h, more preferably of at least 4700 h, and most preferably of at least 8760 h.

According to a preferred embodiment the polymer composition has a failure time in the short term pressure resistance (STPR) test at a stress level of 5.6 MPa at 80° C. of at least 19 h.

According to another preferred embodiment the polymer composition has a failure time in the short term pressure resistance (STPR) test at a stress level of 12.0 MPa at 20° C. of 50 h and higher, more preferably 60 h and higher, and most preferably of 75 h and higher. Typically, the STPR value at a stress level of 12.0 MPa at 20° C. of the composition is is not higher than 20000 h.

The polymer composition of the present invention is preferably a polyolefin composition and most preferably a polyethylene composition.

The polymer composition of the present invention preferably has a density of higher than 950 kg/m³, most preferably higher than 955 kg/m³.

In a preferred embodiment of the present invention, the polymer composition has a content of 1-hexene of more than 2 wt % with respect to the total weight of the polymer composition. Typically, the 1-hexene content in the polymer composition is not higher than 3 wt %.

In a further preferred embodiment of the present invention, the fraction (B) in the base resin of the polymer composition according to the invention has a 1-hexene content of higher than 0.9 mol % with respect to the total amount of substance of the fraction (B), more preferably higher than 1.25 mol %. Typically, the 1-hexene content in fraction (B) is not higher than 2 mol %.

In a preferred embodiment of the present invention, the 1-hexene is the only comonomer in the high molecular weight fraction of the polymer composition. In an even more preferred embodiment of the invention, the 1-hexene is the only comonomer in the base resin and/or the polymer composition.

The polymer composition of the present invention has very good creep resistance at higher temperature, which can be represented by the yield at stress. Hence, the polymer composition preferably has a stress at yield (Tensile testing at 80° C. and strain rate of E-4 s-1) from 5 to 7.5 MPa, more preferably 5.5 to 7.2 MPa and most preferably 6 to 7 MP.

Furthermore, the polymer composition of the present invention preferably has a Charpy Impact Strength (CIS) at 23°° C. of equal to or higher than 30 KJ/m², and/or a Charpy Impact Strength (CIS) at 0° C. of equal to or higher than 21.5 KJ/m², and/or a Charpy Impact Strength (CIS) at −20° C. of equal to or higher than 10.0 KJ/m².

Another characterizing feature of the present invention is the density of the polyethylene base resin. For reasons of strength, the density lies in the medium to high density range. To fulfil the requirements for a PE100 pipe material, the density of the base resin is at least 945 kg/m³. Typically, the density of the base resin is not higher than 950 kg/m³.

Fraction (A) of the base resin may be an ethylene homo-or copolymer. If fraction (A) is an ethylene copolymer, it is preferably a copolymer of ethylene with an alpha-olefin having from 3 to 8 carbon atoms, more preferably 4 to 6 carbon atoms, and most preferably is butene-1 or hexene-1. Preferably, the amount of comonomer, if present, in fraction (A) is 1 mol % or smaller, e.g. from 0.1 to 0.5 mol %. However, preferably fraction (A) of the base resin is an ethylene homopolymer.

Furthermore, preferably, fraction (A) of the base resin of the polymer composition of the present invention has an MFR₂ as measured in accordance with ISO 1133 of higher than 170 g/10 min, more preferably of higher than 200 g/10 min and most preferably of higher than 250 g/10 min. Preferably, the loop density of fraction (A) is equal to or more than 970 kg/m³. Preferably, fraction (A) of the base resin of the polymer composition of the present invention has an MFR₂ lower than 600 g/10 min, more preferably lower than 550 g/10 min and most preferably lower than 350 g/10 min.

Fraction (A) may be contained in the base resin in an amount of from 35 to 46 wt.-%, preferably from 35 to 44 wt.-%, more preferably from 35 to 42 wt.-%, even more preferably from 39 to 41 wt.-%.

Fraction (B) may be contained in the base resin in an amount of from 54 to 65 wt.-%, preferably from 56 to 65 wt.-%, more preferably from 58 to 65 wt.-%, even more preferably from 59 to 61 wt.-%.

Fraction (A) and/or fraction (B) may consist of a single polymer fraction made in one reactor, or may consist of two or more partial fractions made in separate reactors. It is preferred that fraction (A) and/or fraction (B) consist of two partial fractions or a single fraction.

Most preferably, fraction (A) consists of one single fraction or two partial fractions, preferably produced in one or two loop reactors, respectively, and fraction (B) consists of one single fraction, preferably produced in a gas phase reactor.

The base resin of the polymer composition of the present invention comprises fractions (A) and (B) which differ (at least) in their molecular weight. Such resins are designated to be multimodal polyethylenes. The prefix “multi” relates to the number of different polymer fractions the base resin is consisting of. Thus, for example, a base resin consisting of two different fractions only is called “bi-modal”.

The form of the molecular weight distribution curve, i.e. the appearance of the graph of the polymer weight fraction as function of its molecular weight, of such a multimodal polyethylene will show two or more maxima or at least be distinctly broadened in comparison with the curves for the individual fractions.

For example, if a polymer is produced in a sequential multistage process, utilising reactors coupled in series and using different conditions in each reactor, the polymer fractions produced in the different reactors will each have their own molecular weight distribution and weight average molecular weight. When the molecular weight distribution curve of such a polymer is recorded, the individual curves from these fractions are superimposed into the molecular weight distribution curve for the total resulting polymer product, usually yielding a curve with two or more distinct maxima.

It is preferred in the present invention that the base resin is a bimodal polyethylene base resin, i.e. the base resin preferably consists of fractions (A) and (B) and, optionally, a small amount of a prepolymer which is considered a part of the polymer fraction produced in the first reactor.

If one or more fractions of the base resin consist of partial fractions produced in separate reactors, it is preferred that the reaction conditions are chosen so that essential the same polymer is produced therein. This means that if, for example and preferably, the base resin consists of fraction (A) and (B) and fraction (A) is produced as two partial fractions in two separate loop reactors under conditions so that essentially the same or the same polymer is produced therein, the base resin will still be a bimodal resin as it consists of two fractions of different polymers.

Furthermore, the polymer composition preferably has a weight average molecular weight Mw 150 to 350 kg/mol, more preferably of 180 to 320 kg/mol.

Preferably the polymer composition has a number average molecular weight, Mn, in the range of from 9.000 to 20.000 g/mol, more preferably from 9.500 to 18.000 g/mol.

The polymer composition preferably has a molecular weight distribution Mw/Mn of from 18 to 35, more preferably from 19 to 31. Accordingly, the polymer composition of the present invention preferably has a polydispersity index (PI) of from 1.2 to 3.0 Pa⁻¹, more preferably of from 1.3 to 2.8 Pa⁻¹, and most preferably from of 1.5 to 2.5 Pa⁻¹.

Furthermore, the shear thinning index (SHI) is also a very sensitive indicator of the molecular weight distribution. The higher the SHI value the broader the MWD. Therefore, the polymer composition of the present invention has preferably SHI_{(2.7/210)} of at least 18, more preferably of at least 19, and most preferably of at least 20. Moreover, the polymer composition of the present invention has preferably SHI_{(5/300)} of at least 30, more preferably of at least 35, and most preferably of at least 38.

The polymer composition according to the invention has a very good resistance to rapid crack propagation. Accordingly, the polymer composition preferably has a critical temperature Tc in the rapid crack propagation (S4 test) of −6° C. or lower.

The polymer composition of the present invention has preferably a weight ratio of the fraction (A) to the fraction (B) from 42:58 to 35:65.

Furthermore, the polymer composition of the present invention preferably has a melt flow rate MFR₅ from 0.55 to 0.65 g/10 min. Moreover, the composition according of the present invention preferably has a MFR₂₁ in the range of 5 to 25 g/10 min, more preferably in the range of 10 to 18 g/10 min, and most preferably in the range of 11 to 15 g/10 min. Consequently, the polymer composition of the present invention preferably has a FRR_{21/5} in the range of 15 to 25, more preferably in the range of 18 to 23, and most preferably in the range of 19 to 22.

The polymer composition preferably has a white spot rating (WSR) of below 5, more preferably below 4 and most preferably below 3.9. The WSR values indicate the homogeneity of the composition.

In addition to the base resin, usual additives for utilization with polyolefins, such as pigments, stabilizers (antioxidant agents), antiacids and/or anti-UVs, antistatic agents and utilization agents (such as processing aid agents) may be present in the polymer composition. Preferably, the amount of these additives is 10 wt. % or below, further preferred 8 wt. % or below, still more preferred 5 wt. % or below, and still more preferred 4 wt. % or below of the total composition.

Preferably, the base resin makes up at least 89 wt %, more preferably at least 90 wt %, and still more preferably at least 91 wt % of the polymer composition.

In one embodiment of the present invention, the polymer composition of the invention comprises carbon black. Carbon black imparts black colour to the polymer composition and, at the same time, protects the composition from UV radiation. Still further, the addition of carbon black increases the density of the polymer composition compared to that of the base resin.

All embodiments and preferred embodiments as described hereinabove for the base resin and for the polymer composition apply also to the polymer composition comprising carbon black. Furthermore, the following preferred embodiments apply to the polymer composition comprising carbon black in addition.

In this embodiment, it is preferred that the polymer composition consists of the base resin, carbon black, further (usual) additives in any one of the amounts as herein described and optionally any carrier material used to compound the base resin with the pigment(s)/additives. The further additives preferably are present in amount of 3 wt. % or less, more preferred of 2.5 wt. % or less, and most preferred of 2 wt. % or less.

Preferably, carbon black is present in the polymer composition in an amount of 8 wt. % or below, further preferred of 1 to 4 wt. %, even more preferred of 2.0 to 2.5 wt. % of the total composition.

Usually, the amount of carbon black added is selected so that the density of the carbon black-containing polymer composition is from 8 to 15 kg/m³, more preferably from 9 to 14 kg/m³ higher than that of the base resin.

It is preferred that the polymer composition comprising carbon black has a density of from 953 to 965 kg/m³, more preferably from 954 to 960 kg/m³, and most preferably from 955 to 959 kg/m³.

Carbon black is usually added in the form of a master batch, i.e. as a mixture of e.g. an HDPE and carbon black, in which carbon black is present in an amount of e.g. 30 to 50 wt %.

The polymer composition comprising carbon black of the present invention has a weight ratio of the fraction (A) to the fraction (B) from 46:54 to 35:65, preferably from 44:56 to 35:65, and more preferably from 42:58 to 35:65.

In a further preferred embodiment of the present invention, the fraction (B) of the base resin of the polymer composition comprising carbon black according to the invention has a 1-hexene content of higher than 0.9 mol % with respect to the total amount of substance of the fraction (B) in the polymer composition, more preferably higher than 1.25 mol %. Typically, the 1-hexene content in the fraction (B) of the polymer composition is not higher than 2 mol %.

Furthermore, the polymer composition comprising carbon black preferably has a time to failure in the short term pressure resistance (STPR) test at a stress level of 12.0 MPa at 20° C. of at least 75 h.

In a further embodiment of the present invention the polymer composition does not comprise carbon black.

The polymer composition in this embodiment may either comprise no pigment at all, or may comprise a pigment different from carbon black such as a blue or orange pigment.

All embodiments and preferred embodiments as described hereinabove for the base resin and for the polymer composition, apart from those described for the polymer composition comprising carbon black apply also to the polymer composition not comprising carbon black. Furthermore, the following preferred embodiments apply to the polymer composition not comprising carbon black in addition.

In this embodiment, it is preferred that the polymer composition consists of the base resin, optionally one or more pigment(s), further (usual) additives in any one of the amounts as herein described, and optionally any carrier material used to compound the base resin with the pigment(s)/additives. The further additives preferably are present in amount of 3 wt % or less, more preferred of 2.5 wt % or less, and most preferred of 2 wt % or less.

Preferably, the total amount of pigments different form carbon black present in the polymer composition is 2 wt % or below, further preferred is 0.05 to 1 wt %, of the total composition.

Exemplary pigments and the color imparted to the polymer composition are in order to obtain an orange composition a mixture of pigments orange 72 and brown 24 (preferred weight ratio: 1:20) and in order to obtain a blue composition a mixture of pigments blue 29, blue 15:4 and white 6 (preferred weight ratio: 4:5:1).

A pigment or a mixture of pigments is usually added in the form of a master batch, i.e. as a mixture of e.g. an LDPE and the pigment(s), in which the pigment(s) is/are present in an amount of e.g. 5 to 50 wt %.

The polymer composition of the present invention has a weight ratio of the fraction (A) to the fraction (B) from 44:56 to 35:65, and preferably from 42:58 to 35:65.

In a further preferred embodiment of the present invention, the fraction (B) of the base resin of the polymer composition comprising a pigment according to the invention has a 1-hexene content of higher than 0.9 mol % with respect to the total amount of substance of the fraction (B) in the polymer composition, more preferably higher than 1.25 mol %. Typically, the 1-hexene content in the fraction (B) of the polymer composition is not higher than 2 mol %.

Furthermore, it is preferred in this embodiment that the base resin has a number average molecular weight Mn of 9,300 g/mol or higher.

Still further, preferably in the polymer composition not comprising carbon black the base resin preferably has a density of at least 945 kg/m³, more preferably of from 946 to 950 kg/m³, and most preferably from 946.5 to 949 kg/m³.

### Process of the Present Invention

The present invention furthermore relates to a process for producing a polymer composition in any one of the above-described embodiments wherein the base resin is produced in a multistage polymerization process in the presence of a Ziegler-Natta catalyst.

A multi-stage process is a process which makes use of at least two reactors, one for producing a lower molecular weight component and a second for producing a higher molecular weight component. These reactors may be employed in parallel, in which case the components must be mixed after production. More commonly, the reactors are employed in series, such that the products of one reactor are used as the starting material in the next reactor, e.g. one component is formed in the first reactor and the second is formed in the second reactor in the presence of the first component. In this way, the two components are more intimately mixed, since one is formed in the presence of the other.

The polymerization reactions used in each stage may involve conventional ethylene homopolymerization or copolymerization reactions, e.g. gas phase, slurry phase, liquid phase polymerizations, using conventional reactors, e.g. loop reactors, gas phase reactors, batch reactors, etc.

The polymerization may be carried out continuously or batchwise, preferably the polymerization is carried out continuously.

Known two-stage processes are for instance liquid phase-liquid phase processes, gas phase-gas phase processes and liquid phase-gas phase processes. It is also known that these two-stage processes can further be combined with one or more additional polymerization steps selected from gas phase, slurry phase or liquid phase polymerization processes.

In the preferred multistage process, the lower molecular weight and higher molecular weight polymers, fractions (A) and (B), are produced in different polymerization steps, in any order.

The low molecular weight (LMW) polymer (fraction (A)) can be prepared in the first polymerization step and the high molecular weight (HMW) hexene-1 copolymer (fraction (B)) in the second polymerization step. This can be referred to as the normal mode and is preferred.

The HMW copolymer fraction (B) may also be prepared in the first polymerization step and the LMW polymer fraction (A) in the second polymerization step. This can be referred to as the reverse mode.

If the LMW fraction is produced in the first polymerization step, the melt flow rate of the first ethylene fraction (A) can be directly measured as described herein. If the LMW fraction is produced in the second polymerization step, the melt flow rate of the LMW ethylene fraction (A) can be calculated on the basis of the weight ratios of the LMW fraction and the HMW fraction and the molecular weight of the total polymer composition.

In addition, subtracting GPC curves, when fractions of each polymer are known is also possible for determining melt flow rate of the polymer produced in the second stage of a multi-stage polymerization process.

A two-stage process can, for example be a slurry-slurry or a gas phase-gas phase process, particularly preferably a slurry-gas phase process. Optionally, the process according to the invention can comprise one or two additional polymerization steps.

These optional one or two additional polymerization steps preferably comprise slurry polymerization steps.

The slurry and gas phase stages may be carried out using any conventional reactors known in the art. A slurry phase polymerization may, for example, be carried out in a continuously stirred tank reactor; a batch-wise operating stirred tank reactor or a loop reactor. Preferably slurry phase polymerization is carried out in a loop reactor. In such reactors the slurry is circulated with a high velocity along a closed pipe by using a circulation pump. Loop reactors are generally known in the art and examples are given, for instance, in U.S. Pat. Nos. 4,582,816 A, 3,405,109 A, 3,324,093 A, EP 479 186 A and U.S. Pat. No. 5,391,654 A.

The term gas phase reactor encompasses any mechanically mixed, fluidized bed reactor, fast fluidized bed reactor or settled bed reactor or gas phase reactors having two separate zones, for instance one fluidized bed combined with one settled bed zone. Preferably the gas phase reactor for the second polymerization step is a fluidized bed reactor.

In a preferred embodiment of the invention the LMW fraction is produced first and the HMW fraction is produced in the presence of LMW fraction.

The resulting end product consists of an intimate mixture of the polymer fractions from the reactors, the different molecular-weight-distribution curves of these polymers together forming a molecular-weight-distribution curve having a broad maximum or several maxima, i.e. the end product is a multimodal polymer mixture.

It is preferred that the multimodal base resin of the polymer composition according to the invention is a bimodal polyethylene mixture consisting of polymer fractions (A) and (B), optionally further comprising a small prepolymerization fraction. It is also preferred that this bimodal polymer mixture has been produced by polymerization as described above under different polymerization conditions in two or more polymerization reactors connected in series. Owing to the flexibility with respect to reaction conditions thus obtained, it is most preferred that the polymerization is carried out in a loop reactor/a gas-phase reactor combination.

According to a preferred embodiment of the invention, the process comprises a slurry-phase polymerization stage and a gas-phase polymerization stage. One suitable reactor configuration comprises one to two slurry reactors, preferably loop reactors, and one gas-phase reactor. Such polymerization configuration is described e.g. in patent literature, such as in WO 92/12182 A1, WO 96/18662 A1 and WO 2010/054732 of Borealis and known as Borstar technology.

The catalyst may be transferred into the polymerization zone by any means known in the art. It is thus possible to suspend the catalyst in a diluent and maintain it as homogeneous slurry. Especially preferred it is to use oil having a viscosity from 20 to 1500 mPa*s as diluent, as disclosed in WO 2006/063771 A1. It is also possible to mix the catalyst with a viscous mixture of grease and oil and feed the resultant paste into the polymerization zone. Further still, it is possible to let the catalyst settle and introduce portions of thus obtained catalyst mud into the polymerization zone in a manner disclosed, for instance, in EP 428 054 A1.

The polymerization in slurry usually takes place in an inert diluent, typically a hydrocarbon diluent such as methane, ethane, propane, n-butane, isobutane, pentanes, hexanes, heptanes, octanes etc., or their mixtures. Preferably, the diluent is a low-boiling hydrocarbon having from 1 to 4 carbon atoms or a mixture of such hydrocarbons. An especially preferred diluent is propane, possibly containing minor amount of methane, ethane and/or butane.

The temperature in the slurry polymerization is typically from 40 to 115° C., preferably from 60 to 110° C. and in particular from 70 to 100° C. The pressure is from 1 to 150 bar, preferably from 10 to 100 bar.

The slurry polymerization may be conducted in any known reactor used for slurry polymerization. Such reactors include a continuous stirred tank reactor and a loop reactor. It is especially preferred to conduct the polymerization in loop reactor. Hydrogen is fed, optionally, into the reactor to control the molecular weight of the polymer as known in the art.

Furthermore, one or more α-olefin comonomers may be added into the reactor to control the density and morphology of the polymer product. The actual amount of such hydrogen and comonomer feeds depends on the desired melt index (or molecular weight) and density (or comonomer content) of the resulting polymer.

The polymerization in gas-phase may be conducted in a fluidized bed reactor, in a fast-fluidized bed reactor or in a settled bed reactor or in any combination of these.

Typically, the fluidized bed or settled bed polymerization reactor is operated at a temperature within the range of from 50 to 100° C., preferably from 65 to 90° C. The pressure is suitably from 10 to 40 bar, preferably from 15 to 30 bar.

In addition, antistatic agent(s) may be introduced into the slurry and/or gas-phase reactor if needed. The process may further comprise pre-and post-reactors.

The polymerization steps may be preceded by a pre-polymerization step. The pre-polymerization step may be conducted in slurry or in gas phase. Preferably, pre-polymerization is conducted in slurry, and especially in a loop reactor. The temperature in the pre-polymerization step is typically from 0 to 90° C., preferably from 20 to 80° C. and more preferably from 30 to 70° C.

The pressure is not critical and is typically from 1 to 150 bar, preferably from 10 to 100 bar.

The polymerization may be carried out continuously or batch wise, preferably the polymerization is carried out continuously.

In a first example of the present process, polymerizing olefins is accomplished in a multi-stage polymerization process comprising at least one gas-phase reactor for producing ethylene (co)polymers.

In a second example of the present process, polymerizing ethylene with comonomers as herein discussed is accomplished in a multi-stage polymerization process comprising at least one slurry reactor, such as one or two slurry reactors, preferably two slurry reactors, and one gas-phase reactor.

A chain-transfer agent, preferably hydrogen, is added as required to the reactors, and preferably 100 to 800 moles of H₂ per one kmol of ethylene are added to the reactor, when the LMW fraction is produced in this reactor, and 0 to 70 moles of H₂ per one kmol of ethylene are added to the gas phase reactor when this reactor is producing the HMW fraction.

The polymerization is conducted in the presence of an olefin polymerization catalyst. The catalyst preferably is a Ziegler-Natta (ZN) catalyst which generally comprises at least a catalyst component formed from a transition metal compound of Group 4 to 6 of the Periodic Table (IUPAC, Nomenclature of Inorganic Chemistry, 1989), a metal compound of Group 1 to 3 of the Periodic Table (IUPAC), optionally a compound of group 13 of the Periodic Table (IUPAC), and optionally an internal organic compound, like an internal electron donor. A ZN catalyst may also comprise further catalyst component(s), such as a cocatalyst and optionally external additives.

Suitable ZN catalysts preferably contain a magnesium compound, an aluminium compound and a titanium compound supported on a particulate support.

The particulate support can be an inorganic oxide support, such as silica, alumina, titania, silica-alumina, silica-titania or a MgCl₂ based support. Preferably, the support is silica or a MgCl₂ based support.

Particularly preferred Ziegler-Natta catalysts are such as described in EP 1 378 528 A1, preferably in Example 1.

If used, the magnesium compound preferably is a reaction product of a magnesium dialkyl and an alcohol. The alcohol is a linear or branched aliphatic mono-alcohol. Preferably, the alcohol has from 6 to 16 carbon atoms. Branched alcohols are especially preferred, and 2-ethyl-1-hexanol is one example of the preferred alcohols. The magnesium dialkyl may be any compound of magnesium bonding to two alkyl groups, which may be the same or different. Butyl-octyl magnesium is one example of the preferred magnesium dialkyls.

The aluminium compound is a chlorine containing aluminium alkyl. Especially preferred compounds are aluminium alkyl dichlorides and aluminium alkyl sesquichlorides.

The transition metal compound of Group 4 to 6 is preferably a titanium or vanadium compound, more preferably a halogen containing titanium compound, most preferably chlorine containing titanium compound. Especially preferred titanium compound is titanium tetrachloride.

The catalyst can be prepared by sequentially contacting the carrier with the above mentioned compounds, as described in EP 688 794 or WO 99/51646. Alternatively, it can be prepared by first preparing a solution from the components and then contacting the solution with a carrier, as described in WO 01/55230.

Another group of suitable ZN catalysts contain a titanium compound together with a magnesium halide compound acting as a support. Thus, the catalyst contains a titanium compound and optionally a Group 13 compound, for example an aluminium compound on a magnesium dihalide, like magnesium dichloride. Such catalysts are disclosed, for instance, in WO 2005/118655, EP 810 235, WO 2014/096296 and WO 2016/097193.

Suitable activators are group 13 metal compounds, typically group 13 alkyl compounds and especially aluminium alkyl compounds, where the alkyl group contains 1 to 16 C-atoms. These compounds include trialkyl aluminium compounds, such as trimethylaluminium, triethylaluminium, tri-isobutylaluminium, trihexylaluminium and tri-n-octylaluminium, alkyl aluminium halides, such as ethylaluminium dichloride, diethylaluminium chloride, ethylaluminium sesquichloride, dimethylaluminium chloride and the like. Especially preferred activators are trialkylaluminiums, of which triethylaluminium, trimethylaluminium and tri-isobutylaluminium are particularly used.

The amount in which the activator is used depends on the specific catalyst and activator. Typically triethylaluminium is used in such amount that the molar ratio of aluminium to the transition metal, like Al/Ti, is from 1 to 1,000, preferably from 3 to 100 and in particular from about 5 to about 30 mol/mol.

An optional internal organic compound may be chosen from the following classes: ethers, esters, amines, ketones, alcohols, anhydrides or nitriles or mixtures thereof. Preferably, the optional internal organic compound is selected from ethers and esters, most preferably from ethers. Preferred ethers are of 2 to 20 carbon-atoms and especially mono, di or multi cyclic saturated or unsaturated ethers comprising 3 to 6 ring atoms. Typical cyclic ethers suitable in the present invention, if used, are tetrahydrofuran (THF), substituted THF, like 2-methyl THF, di-cyclic ethers, like 2,2-di(2-tetrahydrofuryl)propane, or isomers or mixtures thereof. Internal organic compounds are also often called as internal electron donors.

The composition of the invention preferably is produced in a process comprising a compounding step, wherein the composition, i.e. the blend, which is typically obtained as a polyolefin base resin powder from the reactor, is extruded in an extruder and then pelletised to polymer pellets in a manner known in the art. The extruder may be e.g. any conventionally used extruder. As an example of an extruder for the present compounding step may be those supplied by Japan Steel works, Kobe Steel or Farrel-Pomini, e.g. JSW 460P or JSW CIM90P.

In certain embodiments, the extrusion step is carried out using feed rates of 100 kg/h to 500 kg/h, more preferably 150 kg/h to 300 kg/h.

The screw speed of the extruder may be 200 rpm to 500 rpm, more preferably 300 rpm to 450 rpm.

In certain embodiments, in said extrusion step the SEI (specific energy input) of the extruder may be 100 kWh/ton to 400 kWh/ton, more preferably 150 kWh/ton to 300 kWh/ton.

The melt temperature in said extrusion step is preferably 200° C. to 300° C., more preferably 230° C. to 270° C.

### Article and Use of the Invention

The present invention furthermore relates to an article, preferably a pipe or a pipe fitting, comprising, or consisting of, the polymer composition in any one of the embodiments as herein described.

The invention also relates to the use of a polymer composition in any one of the embodiments as herein described for producing an article, preferably a pipe or a pipe fitting.

Unless explicitly described otherwise, the description of the present invention is to be understood so that one or more of any of the above described preferred embodiments of the invention can be combined with the invention described in its most general features.

For sake of completeness it should be remarked that while certain properties (such as short term pressure resistance) are tested on specific test pipe specimens (such as pipes of a specific thickness and diameter), they are nevertheless properties of the polymer composition used for making the test pipe specimen.

### EXAMPLES

### Measurement methods

### a) Melt Flow Rate

The melt flow rate (MFR) was determined according to ISO 1133 and is indicated in g/10 min. The higher the melt flow rate, the lower the viscosity of the polymer.

The MFR is determined at 190° C. for polyethylene and at a loading of 2.16 kg (MFR₂), 5.00 kg (MFR₅) or 21.6 kg (MFR₂₁).

The quantity FRR (flow rate ratio) is an indication of molecular weight distribution and denotes the ratio of flow rates at different loadings. Thus, FRR_{21/5} denotes the value of MFR₂₁/MFR₅.

### b) Density

Density of the polymer was measured according to ISO 1183-1:2004 (method A) on compression moulded specimen prepared according to EN ISO 1872-2 (February 2007) and is given in kg/m³.

### c) Strain Hardening Modulus

Strain hardening modulus of the compounds was obtained from a tensile stress-strain curve above the natural draw ratio and represents the slope of the increase in the stress-strain trend at very high strains (the strain hardening regime). It was measured at 80° C. and 20 mm/min on preconditioned (120° C./1 h) 300 μm thick specimens according to ISO 18488.

d) Stress at Yield (Tensile Testing at 80° C. and Strain Rate of E-4 s⁻¹)

5a type specimens according ISO 527-2 were milled from compression moulded plaques. Tensile tests were conducted at 80° C. and a strain rate of E-4 s⁻¹ (corresponding to a test speed of 0.3 mm at 50 mm clamping length). The specimens were conditioned at the test temperature for half an hour prior to testing. The yield stress was determined as the first peak in the nominal stress-strain curve. The yielding kinetics in PE at these test conditions display a less pronounced test speed dependence than at room temperature testing and thus correspond better with the long-term yielding properties.

### e) Molecular Weight Properties

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) according to ISO 16014-4:2003 and ASTM D 6474-99 using the following formulas:

$${M}_{n} = \frac{{Σ}_{i = 1}^{N} {A}_{i}}{Σ ( {A}_{i} / {M}_{i} )}$$

$${M}_{w} = \frac{{Σ}_{i = 1}^{N} ( {A}_{i} \times {M}_{i} )}{Σ {A}_{i}}$$

$${M}_{z} = \frac{{Σ}_{i = 1}^{N} ( {A}_{i} \times {M}_{i}^{2} )}{Σ ( {A}_{i} / {M}_{i} )}$$

For a constant elution interval ΔVᵢ, where Aᵢ and Mᵢ are the chromatographic peak slice area and polyolefin molecular weight (MW).

A PolymerChar GPC instrument, equipped with infrared (IR) detector was used with 3× Olexis and 1× Olexis Guard columns from Polymer Laboratories and 1,2,4-trichlorobenzene (TCB, stabilized with 250 mg/l 2,6-Di-tert-butyl-4-methyl-phenol) as solvent at 160° C. and at a constant flow rate of 1 ml/min. 200 μL of sample solution were injected per analysis. The column set was calibrated using universal calibration (according to ISO 16014-2:2003) with at least 15 narrow MWD polystyrene (PS) standards in the range of 0.5 kg/mol to 11500 kg/mol. Mark Houwink constants used for PS, PE and PP are as described per ASTM D 6474-99. All samples were prepared by dissolving 5.0 to 9.0 mg of polymer in 8 ml (at 160° C.) of stabilized TCB (same as mobile phase) for 2.5 hours for PP or 3 hours for PE at 160° C. under continuous gentle shaking in the autosampler of the GPC instrument.

### f) Quantification of Microstructure by NMR Spectroscopy

Quantitative nuclear-magnetic resonance (NMR) spectroscopy was used to quantify the comonomer content of the polymers.

Quantitative ¹³C{¹H} NMR spectra recorded in the molten-state using a Bruker Avance III 500 NMR spectrometer operating at 500.13 and 125.76 MHz for ¹H and ¹³C respectively. All spectra were recorded using a ¹³C optimised 7 mm magic-angle spinning (MAS) probehead at 150° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification (Klimke, K., Parkinson, M., Piel, C., Kaminsky, W., Spiess, H. W., Wilhelm, M., Macromol. Chem. Phys. 2006; 207:382., Parkinson, M., Klimke, K., Spiess, H. W., Wilhelm, M., Macromol. Chem. Phys. 2007; 208:2128., Castignolles, P., Graf, R., Parkinson, M., Wilhelm, M., Gaborieau, M., Polymer 50 (2009) 2373). Standard single-pulse excitation was employed utilising the transient NOE at short recycle delays of 3 s (Pollard, M., Klimke, K., Graf, R., Spiess, H. W., Wilhelm, M., Sperber, O., Piel, C., Kaminsky, W., Macromolecules 2004; 37:813., Klimke, K., Parkinson, M., Piel, C., Kaminsky, W., Spiess, H. W., Wilhelm, M., Macromol. Chem. Phys. 2006; 207:382.) and the RS-HEPT decoupling scheme (Filip, X., Tripon, C., Filip, C., J. Mag. Resn. 2005, 176, 239, Griffin, J. M., Tripon, C., Samoson, A., Filip, C., and Brown, S. P., Mag. Res. in Chem. 2007 45, S1, S198). A total of 16384 (16 k) transients were acquired per spectrum. This setup was chosen due its high sensitivity towards low comonomer contents.

Quantitative ¹³C{¹H} NMR spectra were processed, integrated and quantitative properties determined using custom spectral analysis automation programs. All chemical shifts are internally referenced to the bulk methylene signal (+) at 30.00 ppm (J. Randall, Macromol. Sci., Rev. Macromol. Chem. Phys. 1989, C29, 201).

Characteristic signals corresponding to the incorporation of 1-hexene were observed (J. Randall, Macromol. Sci., Rev. Macromol. Chem. Phys. 1989, C29, 201.) and all contents calculated with respect to all other monomers present in the polymer.

Characteristic signals resulting from isolated 1-hexene incorporation i.e. EEHEE comonomer sequences, were observed. Isolated 1-hexene incorporation was quantified using the integral of the signal at 38.24 ppm assigned to the *B4 sites, accounting for the number of reporting sites per comonomer:

H=I_{*B4}

When characteristic signals resulting from consecutive 1-hexene incorporation, i.e. EHHE comonomer sequences were observed, such consecutive 1-hexene incorporation was quantified using the integral of the signal at 40.46 ppm assigned to the ααB4B4 sites accounting for the number of reporting sites per comonomer:

$$HH = 2 * {I}_{αα B 4 B 4}$$

When characteristic signals resulting from non consecutive 1-hexene incorporation, i.e. EHEHE comonomer sequences were observed, such non-consecutive 1-hexene incorporation was quantified using the integral of the signal at 24.7 ppm assigned to the ββB4B4 sites accounting for the number of reporting sites per comonomer:

$$H EH = 2 * {I}_{β β B 4 B 4}$$

Due to the overlap of the signals from the *B4 and *βB4B4 sites from isolated (EEHEE) and non-consecutivly incorporated (EHEHE) 1-hexene respectively the total amount of isolated 1-hexene incorporation is corrected based on the amount of non-consecutive 1-hexene present:

$$H = {I}_{* B 4} - 2 * {I}_{β β B 4 B 4}$$

With no other signals indicative of other comonomer sequences, i.e. 1-hexene chain initiation, observed the total 1-hexene comonomer content was calculated based solely on the amount of isolated (EEHEE), consecutive (EHHE) and non-consecutive (EHEHE) 1-hexene comonomer containing sequences:

$${H}_{t otal} i = H + H H + H E H$$

Characteristic signals resulting from saturated end-groups were observed. The content of such saturated end-groups was quantified using the average of the integral of the signals at 22.84 and 32.23 ppm assigned to the 2 s and 3 s sites respectively:

$$S = ( 1 / 2 ) * ( {I}_{2 S} + {I}_{3 S} )$$

The relative content of ethylene was quantified using the integral of the bulk methylene (δ+) signals at 30.00 ppm:

$$E = ( 1 / 2 ) * {I}_{δ +}$$

The total ethylene comonomer content was calculated based the bulk methylene signals and accounting for ethylene units present in other observed comonomer sequences or end-groups:

$${E}_{total} = E + ( 2 / 2 ) * H + ( 1 / 4 ) * HH + ( 3 / 4 ) * HEH + ( 3 / 2 ) * S$$

The total mole fraction of 1-hexene in the polymer was then calculated as:

$$f H = {H}_{t otal} / ( {E}_{t otal} + {H}_{t otal} )$$

The total comonomer incorporation of 1-hexene in mole percent was calculated from the mole fraction in the usual manner:

$$H [ mol \% ] = 100 * fH$$

The total comonomer incorporation of 1-hexene in weight percent was calculated from the mole fraction in the standard manner:

$$H [ wt \% ] = 100 * ( fH * 84.16 ) / ( ( fH * 84.16 ) + ( ( 1 - fH ) * 28.05 ) )$$

### g) White Spot Area (WSA) and ISO Rating

A sample of the composition (including a pigment to make the inhomogeneities visible, i.e. carbon black) which was obtained after the compounding steps as described for the different examples below, was analysed by firstly obtaining 6 microtome cuts of 6 different parts of the sample (thickness about 10 micrometer, diameter 3 to 5 mm).

Microtome cuts with a thickness of about 10 μm were made from 6 pellets of the respective sample perpendicular to extrusion direction. The microtome cuts were characterized by light microscopy (ZEISS microscope Axioimager) at a magnification of 100 quantitatively using the White Spot Area method with SCANDIUM software. In this method all detected areas of white particles in all cuts of every sample were summarized and related to the total area of investigation (1.63 mm²). The investigated area of each cut was chosen on a random basis.

The same images used for WSA were also evaluated by the rating

### h) Measure of Homogeneity/White Spot Rating (WSR)

The white spot rating of a compounded composition was determined according ISO 18 553/2002-03-01 as follows:

Pellets of the composition which was obtained after a single compounding step was analysed by collecting 6 different pellets where from each pellet one cut was used (thickness cut 20±2 micrometer). The cut for the measurement of the white spot rating should be taken near the middle of the pellet (sample) with rotation microtome Type Leica RM2265. Preferably the cut is in flow direction of the melt through the whole of the pelletiser.

The cuts were evaluated at a magnification of 100×, and the size and the number of the non-coloured inclusions (“white-spots”, agglomerates, particles) on the total area of each cut was determined. All white spots with a diameter >5 μm were counted. Transmission light microscope Olympus BX41 with XYZ motorised stage from Märzhäuser and particle inspector Software from Olympus was used.

The white spot rating test “homogeneity” is based on the ISO 18553/2002-03-01. In this test, inhomogeneities of the composition present after a single compounding step as described above, which appear as white spots, were determined and rated according to the rating scheme given in ISO 18553/2002-03-01. The lower the composition is rated (less amount of high molecular weight particles) in this test the better is the homogeneity of the composition.

### i) Pressure Test on Notched Pipes (NPT)

The slow crack propagation resistance was determined according to ISO 13479-2009 in terms of the number of hours the pipe withstands a certain pressure at a certain temperature before failure. The pressure test was carried out on notched SDR11 pipes having an outer diameter of 110 mm. A pressure of 9.2 bars and a temperature of 80° C. have been used. Notching as made with a climb milling cutter with a 60° included-angle V-cutter conforming to ISO 6108, having a cutting rate of 0.010±0.002 (mm/rev)/tooth. The used cutter had 24 teeth and the speed of the cutter was 680 rpm. The remaining ligament was 0.82-0.78 times the minimum wall thickness. The depth of the notch as calculated using equation below. h is the notch depth in mm. The four notches are equally placed in the pipe circumference.

The length of the notch was 110±1 mm.

$$h = 0.5 [ {d}_{e m} - \sqrt{( {d}_{e m}^{2} - {b}_{s}^{2} )} ] + 0.866 {b}_{s}$$

where
bₛ: is the width of machined surface of the notch, in millimetres;
dₑₘ: is the measured mean pipe outside diameter, in millimetres.

### j) Rapid Crack Propagation

The rapid crack propagation (RCP) resistance of a pipe may be determined according to a method called the S4 test (Small Scale Steady State), which has been developed at Imperial College, London, and which is described in ISO 13477:2008. The outer diameter of the pipe is about 110 mm or greater and its wall thickness about 10 mm or greater. When determining the RCP properties of a pipe in connection with the present invention, the outer diameter and the wall thickness have been selected to be 110 mm and 10 mm, respectively. The length of the pipe is 785 mm. While the exterior of the pipe is at ambient pressure (atmospheric pressure), the pipe is pressurized internally, and the internal pressure in the pipe is kept constant at a pressure of 4.0 bar positive pressure. The length of the gauge is 590 mm. The pipe and the equipment surrounding it are conditioned to a predetermined temperature. A number of discs have been mounted on a shaft inside the pipe to prevent decompression during the tests. A knife projectile is shot, with well-defined forms, and a mass of 1500 g towards the pipe close to its one end in the so-called initiating zone in order to start a rapidly running axial crack. The speed of the knife is 16 +/−1 m/s. The initiating zone is provided with an abutment for avoiding unnecessary deformation of the pipe. The test equipment is adjusted in such a manner that crack initiation takes place in the material involved, and a number of tests are effected at varying temperatures. The axial crack length in the measuring zone, having a total length of 4.7 diameters, is measured for each test and is plotted against the set test temperature. If the crack length exceeds 4.7 diameters, the crack is assessed to propagate. If the pipe passes the test at a given temperature, the temperature is lowered successively until a temperature is reached, at which the pipe no longer passes the test where the crack propagation exceeds 4.7 times the pipe diameter.

The critical temperature (T_{c}) i.e. the ductile brittle transition temperature as measured according to ISO 13477:2008 is the lowest temperature at which the pipe passes the test. The lower the critical temperature the better, since it results in an extension of the applicability of the pipe.

### k) Short Term Pressure Resistance

The pressure test on un-notched 32 mm SDR 11 pipes having a length of 450 mm was carried out in water-inside and water-outside environment according to ISO 1167-1:2006. End caps type A were used. The time to failure is determined in hours. A hoop stress of 5.0-6.2 MPa (exact stress level can be found in Table 2) and a temperature of 80° C. were applied (STPR (80° C.). Furthermore, A hoop stress of 12.0 MPa and a temperature of 20° C. were applied (STPR (20° C.).

### l) Charpy Impact Strength (CIS)

Charpy impact strength was determined according to ISO 179/1eA:2000 on V-notched samples of 80*10*4 mm³ at 23° C. (Charpy impact strength (23° C.)), at 0° C. (Charpy impact strength (0° C.)) and −20° C. (Charpy impact strength (−20° C.)). Samples were milled from plaques of 4 mm thickness prepared by compression molding according to ISO 293:2004 using the conditions defined in chapter 3.3 of ISO 1872-2:2007.

### m) Rheological Parameters

The characterization of polymer melts by dynamic shear measurements complies with ISO standards 6721-1 and 6721-10. The measurements were performed on an Anton Paar MCR501 stress controlled rotational rheometer, equipped with a 25 mm parallel plate geometry. Measurements were undertaken on compression moulded plates, using nitrogen atmosphere and setting a strain within the linear viscoelastic regime. The oscillatory shear tests were done at 190° C. applying a frequency range between 0.01 and 600 rad/s and setting a gap of 1.3 mm.

In a dynamic shear experiment the probe is subjected to a homogeneous deformation at a sinusoidal varying shear strain or shear stress (strain and stress controlled mode, respectively). On a controlled strain experiment, the probe is subjected to a sinusoidal strain that can be expressed by

$$γ ( t ) = {γ}_{0} sin ( ω t ) \qquad ( 1 )$$

If the applied strain is within the linear viscoelastic regime, the resulting sinusoidal stress response can be given by

$$σ ( t ) = {σ}_{0} sin ( ω t + δ ) \qquad ( 2 )$$

where σ₀ and γ₀ are the stress and strain amplitudes, respectively; ω is the angular frequency; δ is the phase shift (loss angle between applied strain and stress response); t is the time.

Dynamic test results are typically expressed by means of several different rheological functions, namely the shear storage modulus G′, the shear loss modulus, G″, the complex shear modulus, G*, the complex shear viscosity, η*, the dynamic shear viscosity, η′, the out-of-phase component of the complex shear viscosity η″ and the loss tangent, tan η which can be expressed as follows:

$${G}^{′} = \frac{{σ}_{0}}{{γ}_{0}} cos δ [ Pa ] \qquad ( 3 )$$

$${G}^{′} = \frac{{σ}_{0}}{{γ}_{0}} sin δ [ Pa ] \qquad ( 4 )$$

$${G}^{*} = {G}^{′} + {iG}^{″} [ Pa ] \qquad ( 5 )$$

$${η}^{*} = {η}^{′} - i {η}^{″} [ Pa . s ] \qquad ( 6 )$$

$${η}^{′} = \frac{{G}^{″}}{ω} [ Pa . s ] \qquad ( 7 )$$

$${η}^{″} = \frac{{G}^{′}}{ω} [ Pa . s ] \qquad ( 8 )$$

The determination of the so-called Shear Thinning Index, which correlates with the MWD and is independent of Mw, is done as described in equation 9.

$$S H {I}_{( x / y )} = \frac{E t {a}^{*} for ( {G}^{*} = x kPa )}{E t {a}^{*} for ( {G}^{*} = y kPa )} \qquad ( 9 )$$

For example, the SHI_{(0.1/100)} is defined by the value of the complex viscosity, in Pa s, determined for a value of G* equal to 0.1 kPa, divided by the value of the complex viscosity, in Pa s, determined for a value of G* equal to 100 kPa.

The values of storage modulus (G′), loss modulus (G″), complex modulus (G*) and complex viscosity (η*) were obtained as a function of frequency (ω). Thereby, e.g. η*_{300 rad/s} (eta*_{300 rad/s}) is used as abbreviation for the complex viscosity at the frequency of 300 rad/s and η*_{0.05 rad/s} (eta*_{0.05 rad/s}) is used as abbreviation for the complex viscosity at the frequency of 0.05 rad/s.

The loss tangent tan (delta) is defined as the ratio of the loss modulus (G″) and the storage modulus (G′) at a given frequency. Thereby, e.g. tan_{0.05} is used as abbreviation for the ratio of the loss modulus (G″) and the storage modulus (G′) at 0.05 rad/s and tan₃₀₀ is used as abbreviation for the ratio of the loss modulus (G″) and the storage modulus (G′) at 300 rad/s.

The elasticity balance tan_{0.05}/tan₃₀₀ is defined as the ratio of the loss tangent tan_{0.05} and the loss tangent tan₃₀₀.

The polydispersity index, PI, is defined by equation 9.

$$P I = \frac{1 {0}^{5}}{{G}^{′} ( {ω}_{C O P} )} , {ω}_{COP} = ω for ( {G}^{′} = {G}^{″} ) \qquad ( 9 )$$

where, Ω_{COP} is the cross-over angular frequency, determined as the angular frequency for which the storage modulus, G′ equals the loss modulus, G″.

The values are determined by means of a single point interpolation procedure, as defined by Rheoplus software. In situations for which a given G* value is not experimentally reached, the value is determined by means of an extrapolation, using the same procedure as before. In both cases (interpolation or extrapolation), the option from Rheoplus “-Interpolate y-values to x-values from parameter” and the “logarithmic interpolation type” were applied.

### REFERENCES

[1] Rheological characterization of polyethylene fractions” Heino, E. L., Lehtinen, A., Tanner J., Seppälä, J., Neste Oy, Porvoo, Finland, Theor. Appl. Rheol., Proc. Int. Congr. Rheol, 11th (1992), 1, 360-362
[2] The influence of molecular structure on some rheological properties of polyethylene “, Heino, E. L., Borealis Polymers Oy, Porvoo, Finland, Annual Transactions of the Nordic Rheology Society, 1995.).
[3] Definition of terms relating to the non-ultimate mechanical properties of polymers, Pure & Appl. Chem., Vol. 70, No. 3, pp. 701-754, 1998.

### MATERIALS

### Catalyst A

Catalyst A was prepared according to Example 1 of EP 1 378 528 A1.

### Catalyst B

As catalyst B, Lynx 200 from GRACE was used. Polyethylene base resins according to the invention and for comparison were produced using catalyst A or catalyst B as indicated in Table 1.

### Polymer base resin IE1

A loop reactor having a volume of 50 dm³ was operated at a temperature of 70° C. and a pressure of 56 bar. Into the reactor were fed ethylene, propane diluent and hydrogen. Also a solid polymerization catalyst component produced as described above was introduced into the reactor together with triethylaluminium cocatalyst so that the molar ratio of Al/Ti was about 15. The estimated production split was 2 wt %.

A stream of slurry was continuously withdrawn and directed to a loop reactor having a volume of 150 dm³ and which was operated at a temperature of 95° C. and a pressure of 54 bar. Into the reactor were further fed additional ethylene, propane diluent and hydrogen so that the ethylene concentration in the fluid mixture was 5.5 mol % and the hydrogen to ethylene ratio was 373 mol/kmol. The estimated production split was 12 wt %. The ethylene homopolymer withdrawn from the reactor had MFR₂ of 284 g/10 min.

A stream of slurry from the reactor was withdrawn intermittently and directed into a loop reactor having a volume of 350 dm³ and which was operated at 95° C. temperature and 54 bar pressure. Into the reactor was further added a fresh propane, ethylene, and hydrogen so that the ethylene concentration in the fluid mixture was 3.9 mol % and the molar ratio of hydrogen to ethylene was 374 mol/kmol. The ethylene homopolymer withdrawn from the reactor had MFR₂ of 331 g/10 min. The estimated production split was 26 wt. %.

The slurry was withdrawn from the loop reactor intermittently and directed to a flash vessel operated at a temperature of 50° C. and a pressure of 3 bar. From there the polymer was directed to a fluidized bed gas phase reactor operated at a pressure of 20 bar and a temperature of 85° C. Additional ethylene and 1-hexene comonomer, nitrogen as inert gas and hydrogen were added so that the molar ratio of hydrogen to ethylene was 21 mol/kmol and the molar ratio of 1-hexene to ethylene was 59 mol/kmol. The estimated production split was 60 wt %. The polymer had a melt flow rate MFR₅ of 0.56 g/10 min and a density of 945.5 kg/m³.

### Polymer Base Resins CE1-CE4

The procedure of IE1 was repeated by changing reactor conditions as described in Table 1.

Polymerization conditions and properties of the produced base resins and polyethylene compositions of the inventive and comparative examples are shown in Tables 1 and 2, respectively.

TABLE 1

| Example | CE1 | CE2 | CE3 | CE4 | IE1 |
|---|---|---|---|---|---|
| Catalyst | A | A | A | B | A |

Prepoly. reactor

| | | | | | | |
|---|---|---|---|---|---|---|
| Temper- | [° C.] | 70 | 70 | 70 | 50 | 70 |
| ature | | | | | | |
| Pressure | [kPa] | 5583 | 5585 | 5600 | 5544 | 5604 |
| Split | [wt %] | 2 | 2 | 2 | 2 | 2 |

First loop reactor

| | | | | | | |
|---|---|---|---|---|---|---|
| Temper- | [° C.] | 95 | 95 | 95 | N/A | 95 |
| ature | | | | | | |
| Press. | [kPa] | 5363 | 5369 | 5404 | N/A | 5406 |
| C2 conc. | [mol %] | 4.6 | 5.1 | 5.8 | N/A | 5.5 |
| H2/C2 | [mol/kmol] | 387 | 365 | 360 | N/A | 373 |
| ratio | | | | | | |
| Split | [wt %] | 15 | 14 | 12 | N/A | 12 |
| MFR₂ | [g/10 min] | 278 | 248 | 264 | N/A | 284 |

Second loop reactor

| | | | | | | |
|---|---|---|---|---|---|---|
| Temper- | [° C.] | 95 | 95 | 95 | 95 | 95 |
| ature | | | | | | |
| Pressure | [kPa] | 5194 | 5196 | 5392 | 5180 | 5390 |
| C2 conc. | [mol %] | 3.9 | 4.6 | 3.7 | 2.7 | 3.9 |
| H2/C2 | [mol/kmol] | 387 | 406 | 358 | 522 | 374 |
| ratio | | | | | | |
| Split | [wt %] | 29 | 28.5 | 26 | 44 | 26 |
| MFR₂ | [g/10 min] | 358 | 264 | 328 | 149 | 331 |

Gas phase reactor

| | | | | | | |
|---|---|---|---|---|---|---|
| Temp | [° C.] | 85 | 85 | 85 | 85 | 85 |
| Pressure | [kPa] | 2000 | 2000 | 2000 | 2000 | 2002 |
| H2/C2 | [mol/kmol] | 22 | 38 | 46 | 50 | 21 |
| ratio | | | | | | |
| C6/C2 | [mol/kmol] | 55 | 10 | 11 | 49 | 59 |
| ratio | | | | | | |
| Split | [wt %] | 54 | 55.5 | 60 | 54 | 60 |
| MFR₅ | [g/10 min] | 0.61 | 0.59 | 0.55 | 0.40 | 0.56 |
| Density | [kg/m³] | 947.1 | 957.7 | 955.7 | 949.4 | 945.5 |

### Polymer Compositions CE1-CE4 and IE1

The polymer powder of each of the samples IE1 and CE1 to CE4 was mixed under nitrogen atmosphere with 5.5% of carbon black master-batch (40% of Printex alpha A from Orion Engineered Carbons; 60 wt % of a unimodal HDPE carrier resin having a melt flow rate MFR₂ of 12 g/10 min), 2500 ppm of antioxidants and 400 ppm Ca-stearate. The mixture was compounded and extruded under nitrogen atmosphere to pellets using a JSW CIMP90 twin screw extruder so that the SEI was about 220 kWh/ton and the melt temperature 220-250° C. to obtain the polyethylene compositions. The amounts of the different components in the polymer compositions and the properties of the polymer compositions according to the inventive example and the comparative examples are shown in Table 2 below.

TABLE 2
Properties of the polymer composition

| | | CE1 | CE2 | CE3 | CE4 | IE1 |
|---|---|---|---|---|---|---|
| MFR₅ | [g/10 min] | 0.66 | 0.63 | 0.59 | 0.46 | 0.62 |
| MFR₂₁ | [g/10 min] | 14.76 | 14.40 | 11.27 | 11.30 | 12.88 |
| FRR_{21/5} | | 22.4 | 22.9 | 19.1 | 24.6 | 20.8 |
| Density | [kg/m³] | 957.8 | 967.0 | 966.4 | 959.4 | 955.7 |
| Mₙ | [g/mol] | 9515 | 8990 | 10150 | 9520 | 9810 |
| M_{w} | [kg/mol] | 189 | 194.5 | 197.5 | 220 | 192.5 |
| M_{z} | [kg/mol] | 928 | 1020 | 925.5 | 1230 | 909.5 |
| M_{z+1} | [kg/mol] | 1955 | 2280 | 1935 | 2560 | 1885 |
| M_{w}/Mₙ | | 19.9 | 21.6 | 19.5 | 23.1 | 19.6 |
| C6 | [mol %] | 0.66 | 0.10 | 0.10 | 0.48 | 0.76 |
| C6 | [wt %] | 1.96 | 0.30 | 0.29 | 1.41 | 2.24 |
| C6 (HMW) | [mol %] | 1.22 | 0.18 | 0.16 | 0.89 | 1.26 |
| T_{c} | [° C.] | −4.5 | −23.7 | −24.5 | −9.4 | −6.4 |
| SH modulus | [MPa] | 60.8 | 22.9 | 23.8 | 52.4 | 65.1 |
| Stress at yield | [MPa] | 6.35 | 7.01 | 7.05 | 6.57 | 6.29 |
| STPR (80° C.)* | [h] | 176 | 129 | 131 | 3246 | 19 |
| Stress level | [MPa] | 5.6 | 5.0 | 5.0 | 5.4 | 5.6 |
| Failure type | | D | B | B | D | D |
| STPR | [h] | 230 | n.d. | 9900 | 340 | 79 |
| (12.0 MPa, | | | | | | |
| 20° C.)* | | | | | | |
| NPT* | [h] | 3469 | 7.1 | 9.5 | 1104 | >20000+ |
| CIS (23° C.) | [KJ/m²] | 27.6 | 15.6 | 17.9 | n.d. | 32.2 |
| CIS (0° C.) | [KJ/m²] | 20.0 | 12.5 | 14.2 | n.d. | 21.7 |
| CIS (−20° C.) | [KJ/m²] | 8.1 | 7.7 | 11.1 | n.d. | 10.0 |
| WSR | | 3.3 | 3.3 | 3.3 | 3.17 | 3.8 |
| WSA | [%] | 0.03 | 0.09 | 0.07 | 0.02 | 0.07 |
| PI | [Pa⁻¹] | 2.09 | 2.18 | 1.66 | 2.46 | 1.87 |
| SHI_{(2.7/210)} | | 28.9 | 29.8 | 19.08 | 37.29 | 22.7 |
| SHI_{(5/300)} | | 50.4 | 53.2 | 31.1 | 65.4 | 38.3 |

n.d. not determined
*values where measured twice and averaged by geometric average
⁺still no failure

From the measurements performed on these examples, it can be seen in particular the combination of the claimed MFR₅, the split of low and high molecular weight fractions and the comonomer content leads to an advantageous NPT value.

1. A polymer composition comprising a base resin, the base resin comprising:
(A) a first ethylene homo-or copolymer fraction, and
(B) a second ethylene-hexene-1 copolymer fraction,
wherein fraction (A) has a lower molecular weight than fraction (B),
wherein the polymer composition has a content of units derived from 1-hexene of more than 1.5 wt % with respect to the total weight of the polymer composition;
wherein the weight ratio of the fraction (A) to the fraction (B) is from 44:56 to 35:65;
wherein the base resin has a density measured according to ISO 1183-1:2004 (method A) of equal to or higher than 945 kg/m³, and
wherein the polymer composition has a melt flow rate MFR₅ (190° C., 5 kg) determined according to ISO 1133 of equal to or higher than 0.5 g/10 min and equal to or lower than 0.7 g/10 min.

2. Polymer composition according to claim 1, wherein the polymer composition has a content of units derived from 1-hexene of more than 2 wt % with respect to the total weight of the composition.

3. Polymer composition according to claim 1, wherein the fraction (B) has a content of units derived from 1-hexene of higher than 0.9 mol % with respect to the total amount of substance of the fraction (B), preferably higher than 1.25 mol % with respect to the total amount of substance of the fraction (B).

4. Polymer composition according to claim 1, wherein the weight ratio of the fraction (A) to the fraction (B) is from 42:58 to 35:65.

5. Polyethylene composition according to claim 1, wherein fraction (A) of the base resin has a melt flow rate MFR₂ (190° C., 2.16 kg) as measured in accordance with ISO 1133 of 170 to 600 g/10 min, more preferably of 200 to 550 g/10 min and most preferably of 250 to 350 g/10 min.

6. Polymer composition according to claim 1, wherein the polymer composition comprises carbon black and has a density of higher than 953 kg/m³.

7. Polymer composition according to claim 1, wherein the polymer composition has a MFR₅ (190° C., 5 kg) determined according to ISO 1133 of equal to or higher than 0.55 g/10 min and equal to or lower than 0.65 g/10 min.

8. Polymer composition according to claim 1, wherein the polymer composition has a slow crack growth value in a notched pipe test (NPT, 80° C., 4.6 MPa) determined according to ISO 13479-2009 of at least 3500 h.

9. Polymer composition according to claim 1, wherein the polymer composition has a strain hardening modulus determined according to ISO 18488 of 50 MPa or higher.

10. Polymer composition according to claim 1, wherein the polymer composition has a critical temperature Tc in the rapid crack propagation (S4 test) of −6° C. or lower.

11. Polymer composition according to claim 1, wherein the polymer composition has a stress at yield at 80° C. determined according to ISO 527-2 from 5 to 7.5 MPa.

12. A process for producing a polymer composition according to claim 1 wherein the base resin is produced in a multi-stage polymerization process in the presence of a Ziegler-Natta catalyst.

13. An article comprising the polymer composition according to claim 1.

14. The article according to claim 13 being a pipe or pipe fitting.

15. (canceled)

16. Polymer composition according to claim 1, wherein the polymer composition comprises carbon black and has a density of higher than 955 kg/m³.

17. Polymer composition according to claim 1, wherein the polymer composition has a slow crack growth value in a notched pipe test (NPT, 80° C., 4.6 MPa) determined according to ISO 13479-2009 of at least 4700 h.

18. Polymer composition according to claim 1, wherein the polymer composition has a slow crack growth value in a notched pipe test (NPT, 80° C., 4.6 MPa) determined according to ISO 13479-2009 of at least 8760 h.

19. Polymer composition according to claim 1, wherein the polymer composition has a strain hardening modulus determined according to ISO 18488 of 55 MPa or higher.

20. Polymer composition according to claim 1, wherein the polymer composition has a stress at yield at 80° C. determined according to ISO 527-2 from 5.5 to 7.2 MPa.
